(19) United States
(12) Patent Application Publication
(10) Pub. No.: US 2014/0208405 A1
(43) Pub. Date: Jul. 24, 2014

(54) Simplified and Safe User Authentication

(71) Applicant: Tal Hashai, Haifa (IL)

(72) Inventor: Tal Hashai, Haifa (IL)

(21) Appl. No.: 13/747,980

(22) Filed: Jan. 23, 2013

(51) Int. Cl. G06F 21/31

(52) U.S. Cl. CPC G06F 21/31
USPC 726/7

(57) ABSTRACT

Machines, systems and methods for authenticating against one or more access points, the method comprising: receiving data identifying an electronic device and destination information for forwarding a code to a user, in response to the user providing the destination information to a user interface prompt displayed on the electronic device when attempting to authenticate against an access point accessible via the electronic device; generating the code, in response to receiving the destination information and data identifying the electronic device; associating the code with the data identifying the electronic device; and forwarding the code in a message to a destination associated with the destination information, wherein the code is retrieved from the message when the message is received, receiving the code transmitted by way of the electronic device to an authentication server; and authenticating the user against the access point, in response to determining that the code matches related records.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to user authentication for allowing safe access to content, more particularly, to providing a simple and uniform method for a user to authenticate and access one or more services or software products via a single memorable authentication action.

### BACKGROUND

Modern day users may frequent a host of various websites and applications that require a user to enter authentication information at an access point, before the user is able to access the related content or service. Authentication information is typically selected by the user or a third party and generally includes one or more user identification phrases (i.e., user login IDs) associated with one or more passwords.

A user has to remember the authentication information every time the user wants to get passed an access point. Each access point may have different rules and criteria on the type of characters that may be used to set a user ID or a password. This results in a user having to accept or choose different user IDs and passwords for different access points. One would appreciate that memorizing multiple passwords and user IDs for a variety of access points such as websites and applications can become burdensome.

On the other hand, if the user is given the option and elects to use the same user ID and password for the various access points, the user can be exposed to serious security threats in the event that the respective authentication information is compromised. It is desirable to provide a user with a simple authentication option that is safe, memorable and uniform across many access points.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Machines, systems and methods for authenticating against one or more access points are provided. The method comprises receiving data identifying an electronic device and destination information for forwarding a code to a user, in response to the user providing the destination information to a user interface prompt displayed on the electronic device when attempting to authenticate against an access point accessible via the electronic device; generating the code, in response to receiving the destination information and data identifying the electronic device; associating the code with the data identifying the electronic device; and forwarding the code in a message to a destination associated with the destination information, wherein the code is retrieved from the message when the message is received, receiving the code transmitted by way of the electronic device to an authentication server; and authenticating the user against the access point, in response to determining that the code matches records stored in a data structure based on knowledge of the association between the data identifying the electronic device and the code.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary communication environment in accordance with one or more embodiments, wherein user access to content is authenticated.

FIG. 2 is an exemplary flow diagram of a method of using a digital device to authenticate against a point of access, in accordance with one embodiment.

FIG. 3 is a flow diagram of an exemplary method for validating an authentication attempt by a user, in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

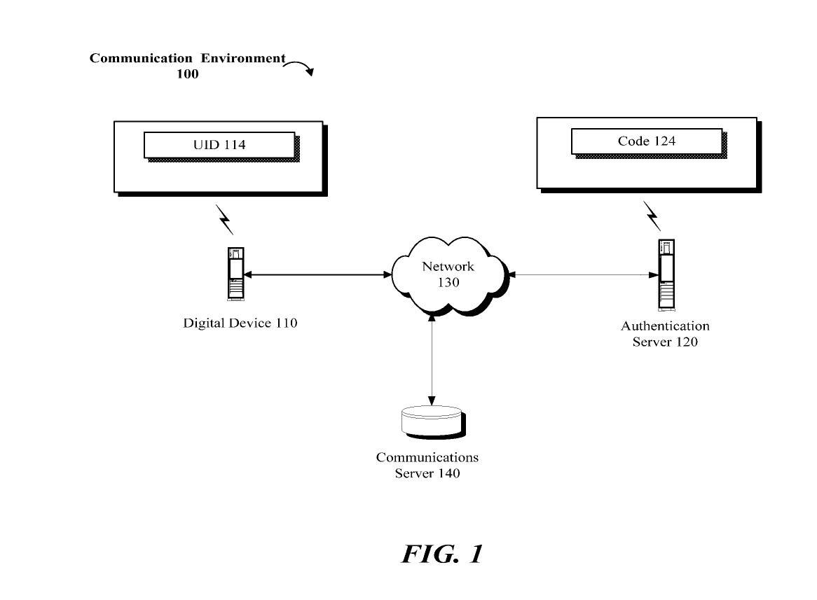

Referring to FIG. 1, an exemplary data communication environment 100 is provided in which a digital device 110 communicates with an authentication server 120 over a communications network 130. Network 130 may be a local area network or a wide area network, such as the Internet. A communications server 140 is optionally provided which may be utilized to allow communication of electronic messages between digital device 110 and authentication server 120.

By way of example, communications server 140 may be a messaging server over which electronic messages are communicated by way of various devices and computing systems connected to network 130. Communications server 140 may support one or more types of messaging protocols, depending on implementation, including short messaging service (SMS) or email messaging services such as the Internet Message Access Protocol (IMAP), Post Office Protocol 3 (POP3), Simple Mail Transfer Protocol (SMTP) or Hypertext Transfer Protocol (HTTP) protocol.

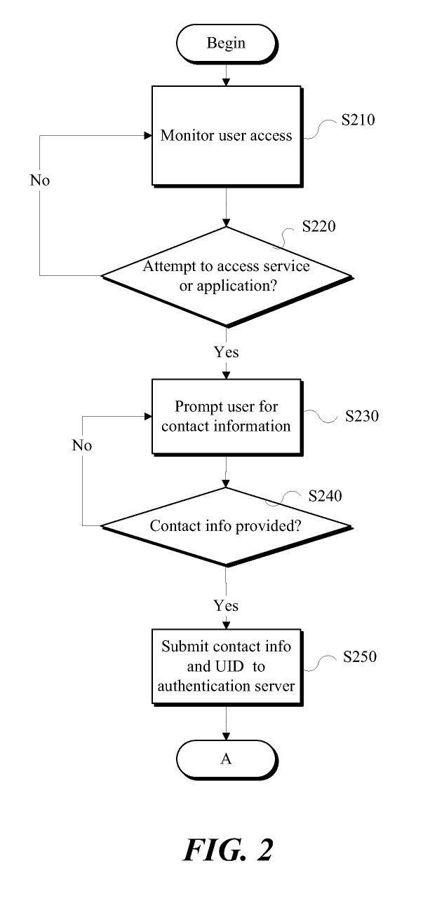

Referring also to FIG. 2, in accordance with one embodiment, authentication means are provided that monitor user access to digital device 110 or a service accessible via digital device 110 (S210). The digital device may be, for example, a computer or a smart phone that is able to communicate with authentication server 120 over network 130 and is capable of opening messaging content (e.g., an email) directed to the user. The service may be a service provided by a remote server to which digital device 110 connects. Alternatively, the service may be provided by a software application (e.g., an “app”) locally running on digital device 110.

In response to determining that the user, using digital device 110, is attempting to access a service or an application or a feature of an application which requires authentication (S220), a user interface screen is displayed prompting the user to provide his contact information or destination information (e.g., email address, SMS address, phone number, etc.) (S230). In response to the user providing his contact information (S240), one or more data packets may be generated that include the user's contact information and a unique identifier (UID) 114 associated with the digital device 110.

The UID may, for example, include a Media Access Control (MAC) address, an Internet Protocol (IP) address or an International Mobile Station Equipment Identifier (IMEI) associated with the digital device 110, or an email address, a phone number, a text messaging address or other contact or destination information that may be used to uniquely identify the user or the digital device 110. The one or more data packets containing the contact information of the user and the device's UID 114 may be forwarded to the authentication server 120 (S250), in response to the user providing his contact information.

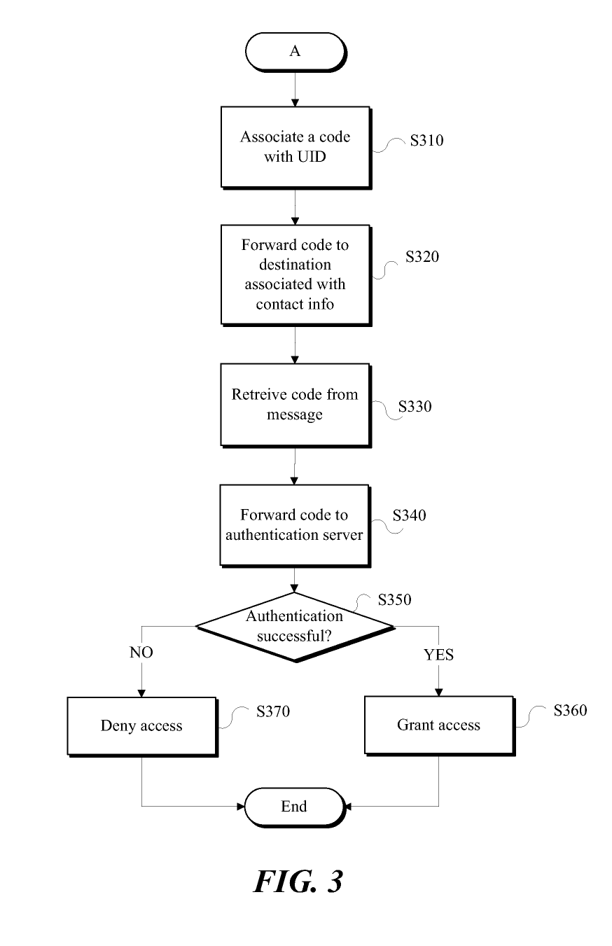

Referring to FIG. 3, once authentication server 120 receives the contact information and the UID 114, authentication server 120 generates a code 124 and associates the code 124 with either the user's contact information or the UID 114 or both, such that the code 124 may be correlated with either the user's contact information (e.g., email address) or the UID 114 at a later time (S310). The user's contact information, the UID 114 and the code 124 may be logged into a data structure (e.g., a lookup table or a relational database, etc.). An association may be established between the UID 114, the contact information and the code 124 so that if one is known by the authentication server 120 the other can be derived from it (e.g., by way a hash algorithm).

Depending on implementation, a correlation between the code 124 and at least one of the UID 112 or the user's contact information may be sufficient for the purpose of authenticating a user as provided in further detail below. Referring back to FIG. 3, authentication server 120 may forward the code 124 as content of an electronic message (e.g., an email message) to the contact information (e.g., email address) provided by the user (S320). The user may then open the electronic message forwarded to his contact information and retrieve the code 124 from the message (S330). For example, if the code 124 is provided in text format, the user may read it and enter the code 124 manually into the user interface prompt generated on digital device 110.

In one embodiment, the entry of the code 124 may be accomplished by providing a hyperlink in the message forwarded to digital device 110 from authentication server 120 (i.e., instead or in addition to the code in text format). In this scenario, the user may select (e.g., click) the hyperlink. Selecting the hyperlink, in one implementation, may cause the code 124 to be retrieved and provided to an application running on the digital device 110 (e.g., the code as embedded in the hyperlink may be passed to the application through a URL scheme, which instructs the digital device 110 to open an application by way of the URL scheme and retrieve the code 124 as a parameter.).

In one implementation, the application may also connect to the messaging service, used to forward the code 124 to the digital device 110, to detect the message sent from authentication server 120 and automatically extract the code 124 from the message content without any intervention from the user. Once the code 124 is retrieved from the message received over the communications server 140 (either manually, automatically or by way of the hyperlink), authentication information including at least the code 124, and optionally the UID 112, are forwarded to authentication server 120 over a communication connection established between the digital device 110 and authentication server 120 (S340).

In one embodiment, instead of the UID 112, it is possible for the user's contact information (e.g., email address) previously entered by the user to be forwarded to authentication server 120 along with the code 124 as authentication information. In either scenario, authentication server 120 upon receiving the authentication information attempts to verify the identity of the user by authenticating the authentication information against the data stored in the data structure (e.g., the lookup table) that includes the user's contact information or UID 124 in association with the code 124.

A verifying scheme may involve determining whether a match exists between the code 124 forwarded to authentication server 120 and the digital device's UID 112 or the user's contact information stored in the server's lookup table. If a match is found then the authentication is successful and access is granted, otherwise the authentication fails and access is denied (S350, S360, S370).

Advantageously, the authentication method and system provided above may be utilized to authenticate against any access point that is configured to communicate with authentication sever 120. This would make it possible for a user to simply and safely access the related content or service protected by one or more access points without having to memorize, lookup or remember multiple different login and password data. In other words, the user provides his contact information in the form of an email address, a messaging address or other contact information which may be used by the authentication server to generate a code 124 and forward the code 124 to the user.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

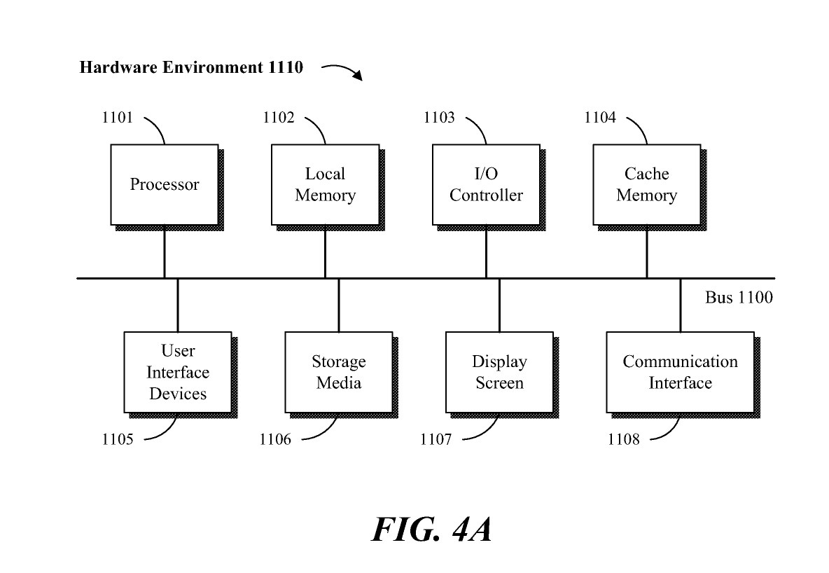

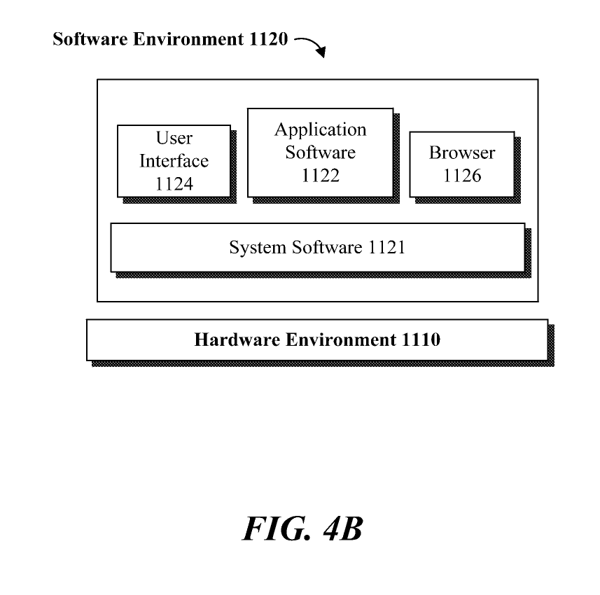

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for authenticating against one or more access points, the method comprising:
receiving data identifying an electronic device and destination information for forwarding a code to a user, in response to the user providing the destination information to a user interface prompt displayed on the electronic device when attempting to authenticate against an access point accessible via the electronic device;
generating the code, in response to receiving the destination information and data identifying the electronic device;
associating the code with the data identifying the electronic device; and
forwarding the code in a message to a destination associated with the destination information,
wherein the code is retrieved from the message when the message is received,
receiving the code transmitted by way of the electronic device to an authentication server; and
authenticating the user against the access point, in response to determining that the code matches records stored in a data structure based on knowledge of the association between the data identifying the electronic device and the code.

2. The method of claim 1, wherein the destination information is an email address to which the user has access.

3. The method of claim 1, wherein the destination information is a messaging address to which the user has access.

4. The method of claim 1, wherein the user manually retrieves the code from the message and enters the code into the user interface prompt displayed on the electronic device causing the code to be transmitted by way of the electronic device to the authentication server.

5. The method of claim 1, wherein the code is automatically retrieved from the message and is transmitted by way of the electronic device to the authentication server by way of software executed on the electronic device.

6. The method of claim 1, wherein the electronic device communicates with the authentication server over a communications network.

7. The method of claim 1, wherein the code is forwarded to the destination associated with the destination information in a message in which the code is embedded in a hyperlink.

8. The method of claim 7, wherein the code is retrieved from the message, in response to the user selecting the hyperlink.

9. The method of claim 8, wherein selecting the hyperlink causes software executed on the electronic device to forward the code to the authentication server.

10. A system for authenticating against one or more access points, the system comprising:
a logic unit for receiving data identifying an electronic device and destination information for forwarding a code to a user, in response to the user providing the destination information to a user interface prompt displayed on the electronic device when attempting to authenticate against an access point accessible via the electronic device;
a logic unit for generating the code, in response to receiving the destination information and data identifying the electronic device;
a logic unit for associating the code with the data identifying the electronic device; and
a logic unit for forwarding the code in a message to a destination associated with the destination information,
wherein the code is retrieved from the message when the message is received,
a logic unit for receiving the code transmitted by way of the electronic device to an authentication server; and
a logic unit for authenticating the user against the access point, in response to determining that the code matches records stored in a data structure based on knowledge of the association between the data identifying the electronic device and the code.

11. The system of claim 10, wherein the destination information is an email address to which the user has access.

12. The system of claim 10, wherein the user manually retrieves the code from the message and enters the code into the user interface prompt displayed on the electronic device causing the code to be transmitted by way of the electronic device to the authentication server.

13. The system of claim 10, wherein the code is automatically retrieved from the message and is transmitted by way of the electronic device to the authentication server by way of a software executed on the electronic device.

14. The system of claim 10, wherein the electronic device communicates with the authentication server over a communications network.

15. A computer program product comprising program code stored on a non-transitory data storage medium, wherein execution of the program code on a processor causes the processor to:
receive data identifying an electronic device and destination information for forwarding a code to a user, in response to the user providing the destination information to a user interface prompt displayed on the electronic device when attempting to authenticate against an access point accessible via the electronic device;
generate the code, in response to receiving the destination information and data identifying the electronic device;
associate the code with the data identifying the electronic device; and
forward the code in a message to a destination associated with the destination information, wherein the code is retrieved from the message when the message is received,
receive the code transmitted by way of the electronic device to an authentication server; and
authenticate the user against the access point, in response to determining that the code matches records stored in a data structure based on knowledge of the association between the data identifying the electronic device and the code.

16. The computer program product of claim 10, wherein the destination information is an email address to which the user has access.

17. The computer program product of claim 10, wherein the user manually retrieves the code from the message and enters the code into the user interface prompt displayed on the electronic device causing the code to be transmitted by way of the electronic device to the authentication server.

18. The computer program product of claim 10, wherein the code is automatically retrieved from the message and is transmitted by way of the electronic device to the authentication server by way of a software executed on the electronic device.

19. The computer program product of claim 10, wherein the electronic device communicates with the authentication server over a communications network.

20. The computer program product of claim 10, wherein the code is forwarded to the destination associated with the destination information in a message in which the code is embedded in a hyperlink.
